(19) United States
(12) Patent Application Publication
(10) Pub. No.: US 2008/0151139 A1
(43) Pub. Date: Jun. 26, 2008

(54) Addressable backlight for LCD panel

(75) Inventor: Jeff Ronald Lynam, Roanoke, VA (US)

Correspondence Address: RATNERPRESTIA, P O BOX 980, VALLEY FORGE, PA, 19482-0980, US

(73) Assignee: ITT Manufacturing Enterprises, Inc.

(21) Appl. No.: 11/644,722

(22) Filed: Dec. 22, 2006

(51) Int. Cl. G02F 1/13357; H01J 9/20

(52) U.S. Cl. 349/62; 349/61; 445/24

(57) ABSTRACT

A display unit includes an LCD panel for providing an output image to a viewer. An APD panel is disposed behind the LCD panel for providing a backlit image to the LCD panel. The LCD panel and the APD panel are vertically stacked one behind the other with an air gap between the APD panel and the LCD panel. The APD panel is configured to provide the backlit image as a first luminance modulated light to the LCD panel, and the LCD panel is configured to provide a second luminance modulated light to the viewer. The combination of the first luminance modulation and the second luminance modulation increases the dynamic range of the display unit. The LCD panel and the APD panel have their respective output images synchronized to each other.

### TECHNICAL FIELD

The present invention relates, in general, to a display unit and, more specifically, to a display unit having an LCD panel at the front of the unit, and an APD panel disposed behind the LCD panel. The APD panel provides an addressable backlight image to the LCD panel.

### BACKGROUND OF THE INVENTION

Liquid crystal materials emit no light of their own. They do, however, reflect and transmit light from external light sources. Accordingly, when using liquid crystal materials in a display, it is necessary to back light the display.

A conventional flat screen liquid crystal display (LCD) includes a matrix of thin film transistors (TFTs) fabricated on a substrate of glass or another transparent material. A liquid crystal film is disposed over the substrate and the TFTs. Addressing of the TFTs by gate lines deposited on the substrate during TFT fabrication causes selected TFTs to conduct electrical current and charges the liquid crystal film in the vicinity of the selected TFTs. Charging of the liquid crystal film alters the opacity of the film, and affects a local change in light transmission of the liquid crystal film. Hence, the TFTs define display cells or pixels in the liquid crystal film. Typically, the opacity of each pixel is charged to one of several discrete opacity levels to implement a luminosity gray scale, and so the pixel is a gray scale pixel.

Because a backlit LCD varies only the luminosity of the light to produce gray scale pixels, an LCD also requires means for coloring the pixels. U.S. Pat. No. 6,975,369 describes a method of coloring LCD pixels, which includes use of a colorizing backlight. As described, an array of backlight elements each includes a first component color light emitting diode (LED), a second component color LED and a third component color LED, such as red, green and blue, respectively. Each of the three LEDs is optically coupled to a corresponding pixel of the LCD. In this arrangement, each component color LED corresponds to a color pixel. In operation, the red, green and blue LEDs emit light toward the LCD. The luminance of each of the pixels is modulated via the LCD pixels using the TFTs to create a transmitted light luminance modulation across the area of the display. In particular, LCD pixels coupled to the red LEDs modulate the red light component, LCD pixels coupled to the green LEDs modulate the green light component, and LCD pixels coupled to the blue LEDs modulate the blue light component. By selective operation of the pixels for each backlight element, a desired color blending is achieved. The combination of gray scale pixels defines a full-color pixel.

Conventional flat screen displays suffer certain disadvantages. First, the colorizing backlight of the conventional flat screen display modulates only chrominance of the backlight. As a result, luminance range of the flat screen display is limited. Second, conventional flat screen displays require complex controls for turning on the LEDs at certain levels to produce blended colors, making manufacture of conventional flat screen displays difficult and expensive.

### SUMMARY OF THE INVENTION

To meet this and other needs, and in view of its purposes, the present invention provides a display unit and method of manufacturing the display unit. In one embodiment of the invention, the display unit includes an LCD panel for providing an output image to a viewer. An APD panel is disposed behind the LCD panel for providing a backlit image to the LCD panel. The LCD panel and the APD panel are separately manufactured and, subsequently, vertically stacked one behind the other. Furthermore, the APD panel is configured to provide the backlit image as a first luminance modulated light to the LCD panel, and the LCD panel is configured to provide a second luminance modulated light to the viewer. The APD panel is also configured to provide a chrominance modulated light to the viewer.

The present invention also includes a method of manufacturing a display unit. The method includes the following steps:
(a) separately manufacturing an LCD panel and an APD panel,
(b) vertically stacking the LCD panel and the APD panel one behind the other.

In addition, the present invention includes the step of synchronizing an image provided by the LCD panel with an image provided by the APD panel.

Furthermore, the present invention includes steps of modulating first luminance levels and first chrominance levels of light intensity provided by the APD panel toward the LCD panel, and modulating second luminance levels of light intensity provided by the LCD panel toward the viewer.

### BRIEF DESCRIPTION OF THE DRAWINGS

The invention is best understood from the following detailed description when read in connection with the accompanying drawing. Included in the drawing are the following figures:

FIG. 1 is a side view of a liquid crystal display (LCD), according to an exemplary embodiment of the present invention;

FIG. 2 is an exploded view of a liquid crystal display, according to an exemplary embodiment of the present invention;

FIG. 3 is a side view of an exemplary relationship between an active pixel display (APD) and a liquid crystal display, according to an embodiment of the present invention;

FIG. 4 is a front view of the top left corner of a combined display format illustrating a 4:1 relationship of background active color pixels to foreground LCD pixels, according to an exemplary embodiment of the present invention;

FIG. 5 is a front view of the top left corner of a combined display format illustrating a 1:1 relationship of background active color pixels to foreground LCD pixels, according to an exemplary embodiment of the present invention;

FIG. 6 is a front view of the top left corner of a combined display format illustrating a 1:1.6 relationship of background active color pixels to foreground LCD pixels, according to an exemplary embodiment of the present invention;

FIG. 7 is a block diagram showing synchronization between an LCD and an APD, according to an exemplary embodiment of the present invention;

FIG. 8 is a side view of an optional field format magnifier sandwiched between an LCD and an APD, according to an exemplary embodiment of the present invention;

FIG. 9 is a side view of an optional field format minifier sandwiched between an LCD and an APD, according to an exemplary embodiment of the present invention;

FIG. 10A is a side view of a relay lens for frame field matching between an LCD and an APD, according to an exemplary embodiment of the present invention;

FIG. 10B is a side view of a 1:1 fiber optic for frame field matching between an LCD and an APD, according to an exemplary embodiment of the present invention; and

FIG. 10C is a side view of a minifying fiber optic taper for frame field matching between an LCD and an APD, according to an exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

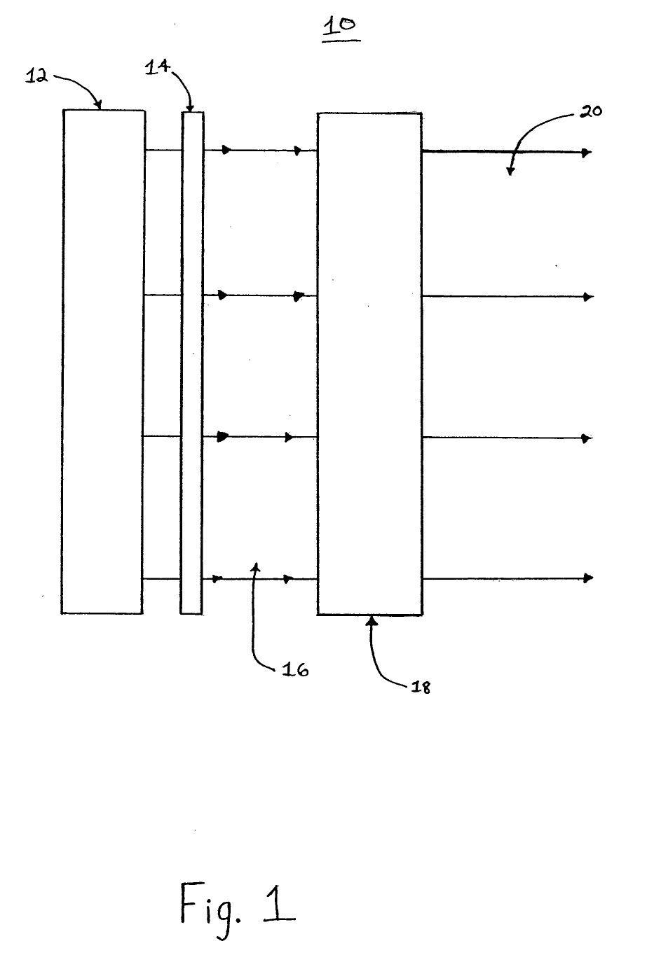

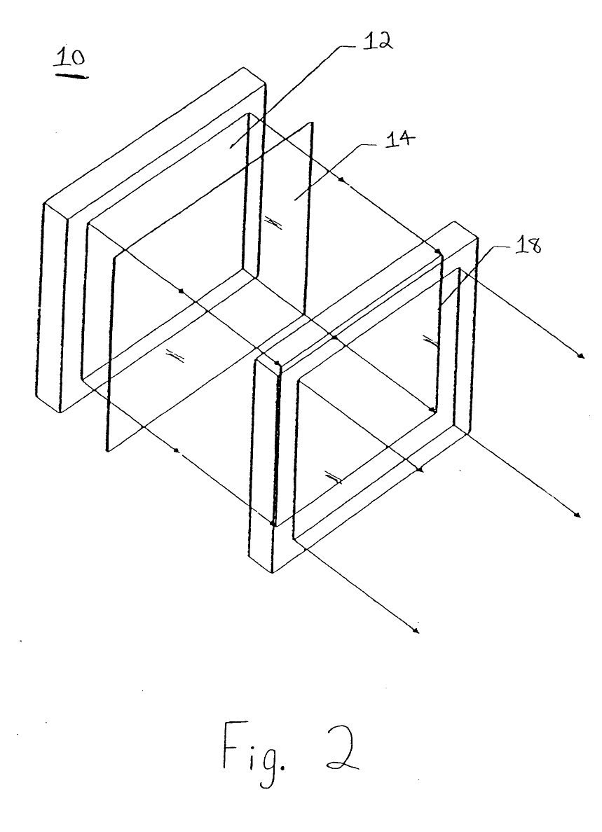

With reference to FIGS. 1 and 2, a display unit 10 according to an exemplary embodiment of the present invention includes an active pixel display (APD) 12 disposed behind a liquid-crystal display (LCD) 18. The LCD 18 may be, for example, a transmissive or transflexive LCD. The APD 12 provides a backlight source for LCD 18. FIGS. 1 and 2 also show an optional field format modifier 14 that may be used to modify the relationship between the active display area of APD 12 and the active display area of LCD 18. Optional field format modifier 14 is described in more detail later.

As shown in FIG. 1, APD 12 emits chrominance and luminance modulated light into illumination output region 16. The LCD 18 further modulates the luminosity of the light to form a final image in display output region 20.

The APD 12 may be any active pixel display of any light emitting technology. For example, APD 12 may be an active matrix organic light emitting diode (AMOLED).

An AMOLED is made up of an array of organic light emitting diodes (OLEDs). Each OLED includes an anode layer and a cathode layer, with at least two organic semiconductor layers sandwiched between them. One of the organic semiconductor layers is a conductor of positively charged holes and the other is a conductor of electrons. When a voltage is applied to the device, the excess electrons jump the gap towards the holes and emit light. The OLED may be made to emit colored light, for example, by placing a color filter over a white-light-emitting OLED.

The anode layer of each OLED is disposed on top of a thin film transistor (TFT) array that forms a matrix. The TFT matrix controls both the chrominance and luminance of the OLEDs. Addressing of the TFTs by gate lines deposited on the substrate during TFT fabrication causes selected TFTs to conduct electrical current. Those selected TFTs turn on selected OLEDs to produce blended colors as well as different luminance values, thus forming an image.

Thus, active pixel display 12 modulates both luminance and chrominance. When used as a backlight for LCD 18, active pixel display 12 acts as a primary light source and a light modulator and LCD 18 acts as a secondary light modulator. In this way, LCD 18 provides an additional level of luminance control. For example, if each APD pixel provides 256 individual luminance levels, and each LCD pixel provides 16 additional luminance levels, then system 10 has a dynamic range of 4096 luminance levels per pixel.

Further, using APD 12 as a backlight for LCD 18 provides for easy assembly. The present invention advantageously assembles two separate and independently manufactured units. Both units, namely the APD panel and the LCD panel, may be separately manufactured in any conventional manner. After manufacture, both units may be integrated to form display unit 10, where APD panel 12 is disposed behind LCD panel 18. The resulting dynamic range of display unit 10 is the product of the individual dynamic range of the APD panel and the individual dynamic range of the LCD panel.

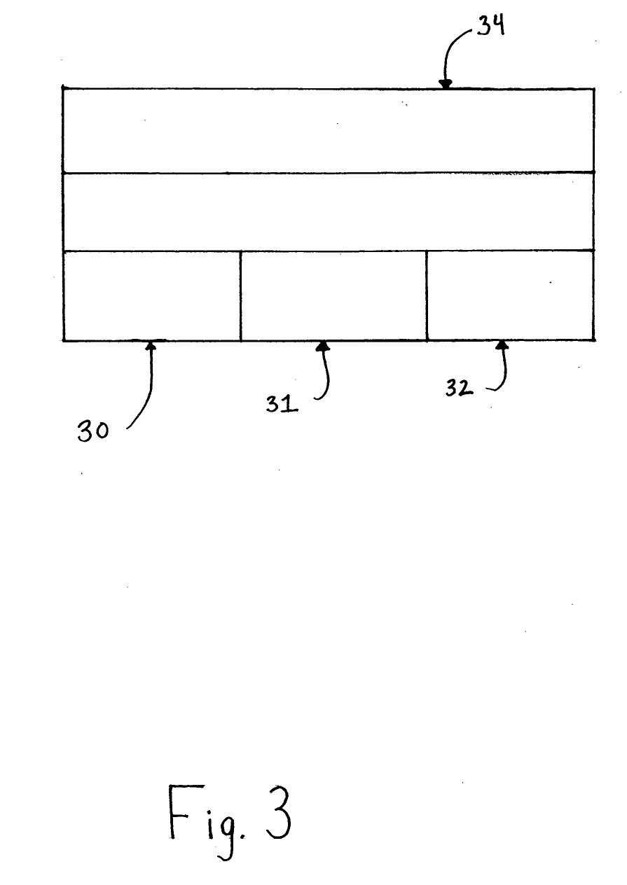

FIG. 3 shows a general arrangement of APD pixels 30, 31 and 32 disposed behind LCD pixel 34. For example, pixel 30 emits red light, pixel 31 emits green light, and pixel 32 emits blue light. In this manner, each LCD pixel 34 emits green light, blue light, red light or any blended color produced by combining the three colors. As is known in the art, selective blending of three primary colors such as red, green and blue generally produces a full range of colors suitable for color display purposes. As previously described, each APD pixel 30, 31 and 32 emits light that is both luminance modulated and chrominance modulated in the direction of LCD pixel 34. The LCD pixel 34 then provides additional luminance modulation.

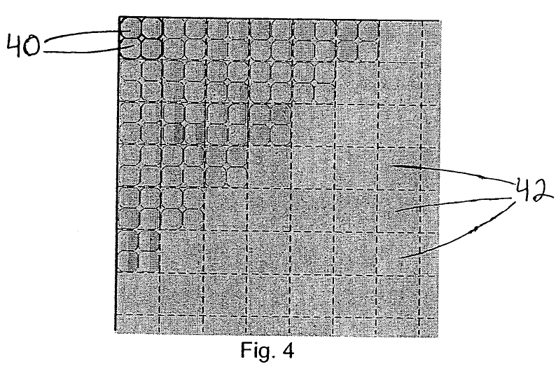

FIGS. 4-6 show a top corner portion of various combined display formats and illustrate the relationship of background active color pixels to respective foreground LCD pixels. Pixel overlay relationship is a direct factor of the size spacing and fill factor of each individual pixel (in the APD) with respect to pixel or pixels of a corresponding secondary display (e.g. the LCD).

Referring first to FIG. 4, there is shown a 4:1 pixel overlay relationship. As shown, active color pixels 40 are smaller than LCD pixel 42. More specifically, four active color pixels 40 are disposed behind one LCD pixel 42.

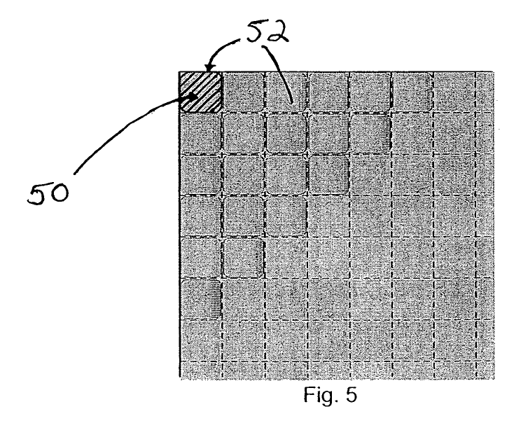

As another example, FIG. 5 shows a 1:1 pixel overlay relationship. As shown, each active color pixel 50 is the same size as each LCD pixel 52. Thus, each active color pixel 50 is disposed behind one LCD pixel 52.

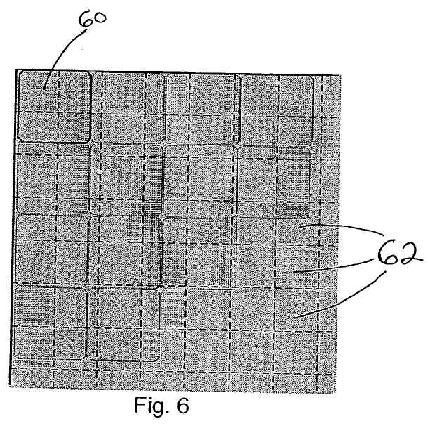

Still another example, FIG. 6 shows a 1:1.6 pixel overlay relationship. As shown, each active color pixel 60 is larger than each LCD pixel 62, by as much as 60%.

It will be appreciated that one skilled in the art may arrange the background active color pixels and the foreground LCD pixels to form any other pixel overlay relationship.

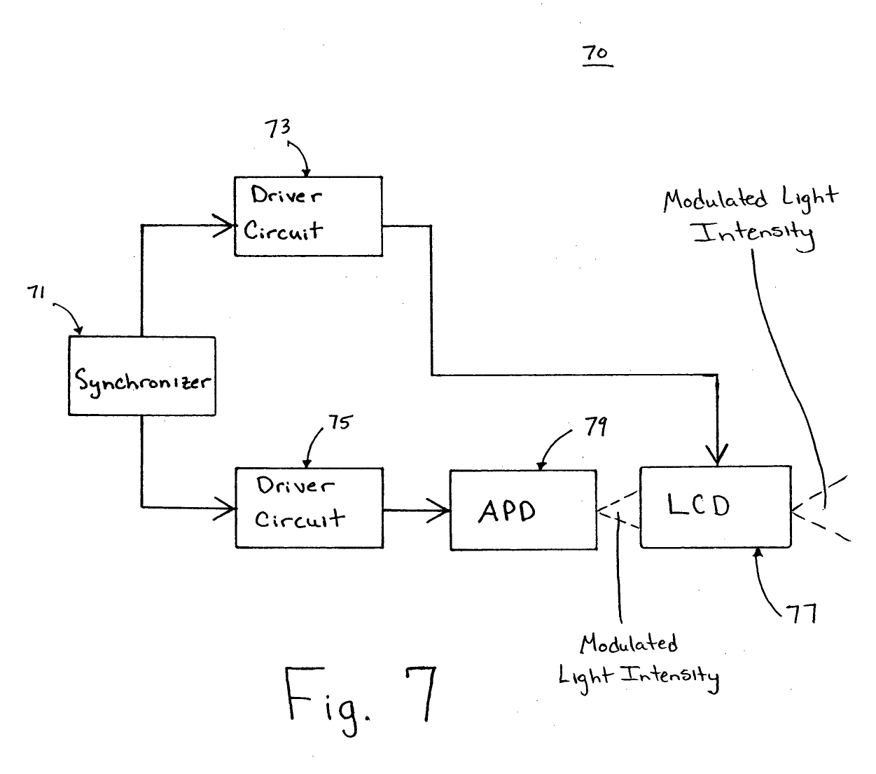

FIG. 7 illustrates an example of synchronization of the APD pixels with the LCD pixels. As shown, display unit 70 includes synchronizer 71, driver circuits 73 and 75, LCD 77 and APD 79. Synchronizer 71 generates a clock signal having a predetermined frequency. The clock signal is provided to both driver circuit 73 and driver circuit 75. Driver circuit 73 controls LCD 77 and driver circuit 75 controls APD 79. In this manner, display unit 70 synchronizes the pixels of LCD 77 with the pixels of LCD 79 to the same clock signal. A synchronized image of luminance values from both LCD 77 and APD 79 and chrominance values from APD 79 are displayed by the output of the front panel of LCD 77, as best shown in FIGS. 1-3.

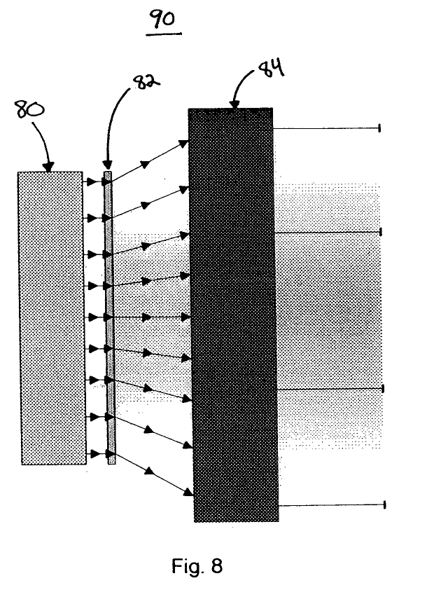

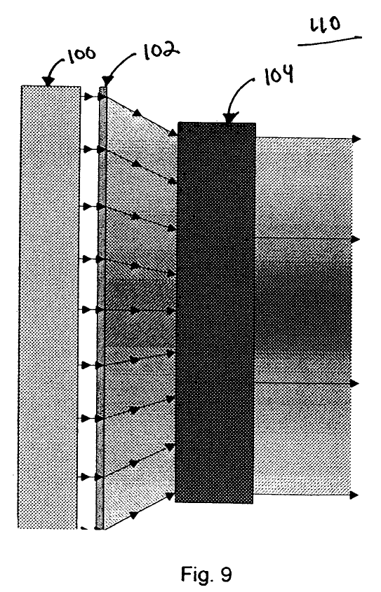

FIGS. 8 and 9 illustrate an optional field format modifier inserted between an LCD panel and an APD panel. Optional field format modifier 82 or 102 may be used to optimize the active pixel-to-LCD display format overlay relationship and/or the individual pixel-to-pixel overlay dimensional relationship. Field format modifiers 82 or 102 may be placed between the APD panel and the LCD panel. The field format modifier may be, for example, a relay lens, a micro-fresnel lens, and/or a fiber optic taper.

Referring to FIG. 8, display unit 90 includes APD 80, field format magnifier 82 and LCD 84. In the exemplary embodiment, LCD 84 has a larger display area than APD 80. Field format magnifier 82 directs the light emitted from APD 80 toward a larger area of LCD 84. In this manner, an APD may be used to backlight an LCD that has a larger display area than the APD.

Referring to FIG. 9, display unit 110 includes APD 100, field format minifier 102 and LCD 104. In the exemplary embodiment, LCD 104 has a smaller display area than APD 100. Field format minifier 102 directs the light emitted from APD 100 toward a smaller area of LCD 104. In this manner, an APD may be used to backlight an LCD that has a smaller display area than the APD.

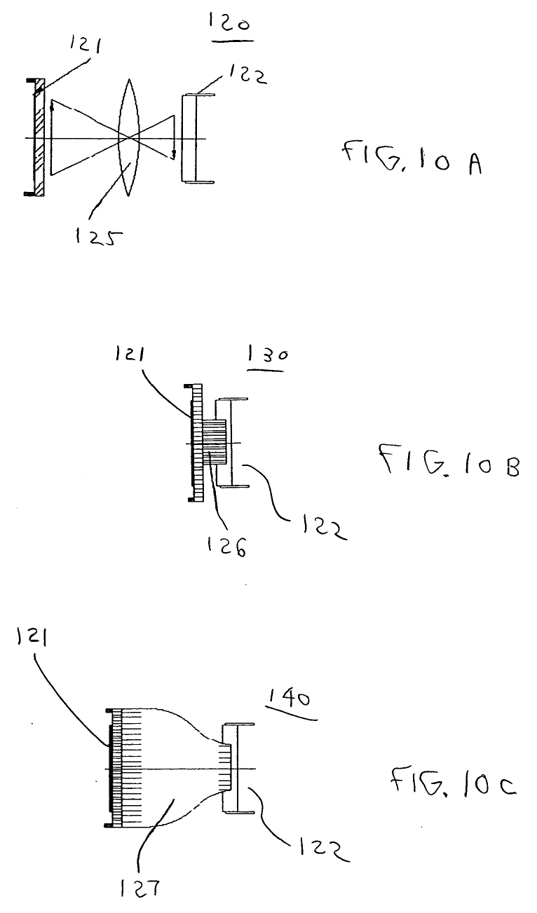

Referring to FIGS. 10A, 10B and 10C, there are shown exemplary field format modifiers. Display unit 120 includes relay optic (lens) 125 disposed between APD 121 and LCD 122 (only portions of an APD and an LCD are shown). Relay optic 125 is separated completely from the APD and the LCD by way of an air gap on both sides of the relay optic. As another example, display unit 130 includes a 1:1 fiber optic disposed between APD 121 and LCD 122. Still another example, display unit 140 includes a minifying fiber optic taper disposed between APD 121 and LCD 122 for reducing the size of the image between the APD and the LCD. Although not shown, a magnifying fiber optic taper (the taper is an inverse of the taper shown in FIG. 10C) may also be used for enlarging the image between the APD and the LCD.

Actual design intent affects how and when magnification or minification is applied. In cases where the design intent is to maximize or more equally match the overall format areas of each display, less consideration may be given to a 1-to-1 pixel overlay match and some fractional overlay may result. In cases where pixel-to-pixel matching is more important, less concern may be given to an under-filled or over-filled field display.

What is claimed:

1. A display unit comprising
an LCD panel for providing an output image to a viewer, and
an APD panel, disposed behind the LCD panel, for providing a backlit image to the LCD panel;
wherein the LCD panel and the APD panel are separately manufactured and, subsequently, vertically stacked one behind the other,
the APD panel is configured to provide the backlit image as a first luminance modulated light to the LCD panel, and
the LCD panel is configured to provide a second luminance modulated light to the viewer.

2. The display unit of claim 1 further including
the APD panel configured to provide a chrominance modulated light to the viewer.

3. The display unit of claim 1 wherein
the first luminance modulated light has a first dynamic range, the second luminance modulated light has a second dynamic range, resulting in a total dynamic range equal to the product of the first dynamic range and the second dynamic range.

4. The display unit of claim 1 further including
a field format magnifier disposed between the APD panel and the LCD panel for enlarging the backlit image provided to the LCD panel.

5. The display unit of claim 4 wherein
the field format magnifier is a micro-fresnel lens.

6. The display unit of claim 1 further including
a field format minifier disposed between the APD panel and the LCD panel for reducing the backlit image provided to the LCD panel.

7. The display unit of claim 6 wherein
the field format minifier is a micro-fresnel lens.

8. The display unit of claim 1 further including
an air-filled gap formed between the LCD panel and the APD panel,
wherein the air-filled gap completely separates the LCD panel from the APD panel.

9. The display unit of claim 1 wherein
the APD panel includes an array of active matrix organic light emitting diodes.

10. The display unit of claim 1 including
a synchronizer module for synchronizing the output image to the viewer with the backlit image from the APD panel.

11. The display unit of claim 1 further including
a relay optic disposed between the APD panel and the LCD panel for display field format matching between the APD panel and the LCD panel.

12. The display unit of claim 1 further including
a fiber optic disposed between the APD panel and the LCD panel for display field format matching between the APD panel and the LCD panel.

13. The display unit of claim 1 further including
a minifying fiber optic taper disposed between the APD panel and the LCD panel for display field format matching between the APD panel and the LCD panel.

14. A method of manufacturing a display unit comprising the steps of:
(a) separately manufacturing an LCD panel and an APD panel, and
(b) vertically stacking the LCD panel and the APD panel one behind the other.

15. The method of claim 14 further including the step of:
(c) vertically stacking a field format magnifier between the LCD panel and the APD panel.

16. The method of claim 14 further including the step of:
(c) vertically stacking a field format minifier between the LCD panel and the APD panel.

17. The method of claim 14 further including the steps of:
configuring the APD panel to output a first luminance modulated light to the LCD panel;
configuring the LCD panel to output a second luminance modulated light to a viewer.

18. The method of claim 17 further including the step of:
synchronizing the first luminance modulated light with the second luminance modulated light.

19. The method of claim 17 further including the step of:
configuring the APD panel to output a chrominance modulated light to the LCD panel.
